(19) United States
(12) Patent Application Publication
(10) Pub. No.: US 2003/0046109 A1
(43) Pub. Date: Mar. 6, 2003

(54) Medical information system for improving efficiency of clinical record creating operations

(75) Inventor: Akinobu Uchikubo, Iruma-shi (JP)

Correspondence Address: Paul J. Esatto, Jr., Scully, Scott, Murphy & Presser, 400 Garden City Plaza, Garden City, NY, 11530, US

(73) Assignee: OLYMPUS OPTICAL CO., LTD., TOKYO (JP)

(21) Appl. No.: 10/224,604

(22) Filed: Aug. 20, 2002

(30) Foreign Application Priority Data
Aug. 30, 2001 (JP) 2001-262353
Aug. 31, 2001 (JP) 2001-264856

(51) Int. Cl. G06F 17/60

(52) U.S. Cl. 705/2; 705/3

(57) ABSTRACT

In a medical information system, an in-hospital server stores patient registration information from a patient registration terminal in a hospital, and medical images related to said patient. A surgery unit server reads out registration information such as the name, the date of birth, and the diagnosis history of the patient having surgery, and medical images related to the patient from the in-hospital server. A first controller reads out medical information on said patient, which is accumulated in the in-hospital server via the surgery unit server by inputting patient information (the name of the patient, ID code) for identifying the patient by an input device, and displays this information on a display device. At this time, in the event that the patient information which is input from the input device does not agree with the patient information which is registered in the in-hospital server, the information to that effect is displayed on a display device.

This application claims benefit of Japanese Application No. 2001-262353 filed in Japan on Aug. 30, 2001, and Japanese Application No. 2001-264856 filed in Japan on Aug. 31, 2001, the contents of which are incorporated by this reference.

### BACKGROUND OF THE INVENTION

1. Field of the Invention

The present invention relates to a medical information system having functions for creating clinical records where medical treatment information is recorded.

2. Description of the Related Art

In recent years, medical information processing apparatuses, which enable users to generate clinical records electronically by inputting information such as medical treatment information for patients, endoscope image data acquired by endoscope examination, and so forth, are being used in medical institutions, or the like.

For example, Japanese Unexamined Patent Application Publication No. 2000-33072 describes means for creating clinical records by operators inputting medical treatment information in a screen, acquiring endoscope image data from an endoscope device, or editing input information, at each step, following operation guides displayed on the screen.

However, with conventional techniques, for example, such as indicated in Japanese Unexamined Patent Application Publication No. 2000-33072, the troublesome procedures of inputting medical treatment information of a patient in the screen, or the troublesome procedures of acquiring endoscope images occur every time, and since means for acquiring surgical device information such as operation information in the event that an operator operates an surgical device other than endoscopes, such as an electrocauterizer device, a gas insufflator, an ultrasonic surgical device, or the like, and measurement information and so forth obtained by these surgical devices, are not described therein, the troublesome procedures for inputting these medical device information in the screen occur, and time is required for work for collecting and accumulating various types of medical treatment information, so a great deal of time is spent in daily clinical record creating operations.

While the practice of electronic clinical records has become widespread in hospitals, making surgery information into electronic files is lagging.

The information for identifying the patient (e.g., name, ID, and so forth) is indispensable to make online reference to the patient information of the medical information processing system in the hospital. However, it is possible that trouble might occur in which patients having surgery in medical sectors such as multiple surgery rooms are mistaken one for another, due to human error.

### SUMMARY OF THE INVENTION

It is an object of the present invention to provide a medical information system for reducing time of accumulation, as well as for realizing error-free clinical record management operations by performing accumulation of medical treatment information automatically.

It is another object of the present invention to provide a medical information system which can prevent patients from being mistaken one for another beforehand.

A medical information system according to the present invention comprises a controller which is connected to a surgery system for receiving information from the above surgery system, a server which is connected to the above controller, for accumulating identification information for identifying a patient having surgery with the above surgery system, and an input device which is connected to the above controller for inputting the above identification information, wherein the above controller collates the identification information from the input device with that from the server.

Other features and advantages of the present invention will become fully clear by the following description.

### BRIEF DESCRIPTION OF THE DRAWINGS

FIGS. 1 through 3 relate to a first embodiment of the present invention, wherein;

FIG. 1 is an explanatory diagram which indicates the overall configuration of the medical information processing system;

FIG. 2 is a block diagram which indicates the structure of a first controller shown in FIG. 1; and

FIG. 3 is an explanatory diagram which indicates a display example of summarized information screen displayed on a display device shown in FIG. 1;

FIGS. 4 and 5 relates to a second embodiment of the present invention, wherein;

FIG. 4 is an explanatory diagram which indicates the overall configuration of the medical information processing system; and

FIG. 5 is a block diagram which indicates the structure of the first controller shown in FIG. 4.

### DETAILED DESCRIPTION OF THE PREFERRED EMBODIMENTS

Embodiments of the present invention will be described below with reference to the drawings.

First Embodiment

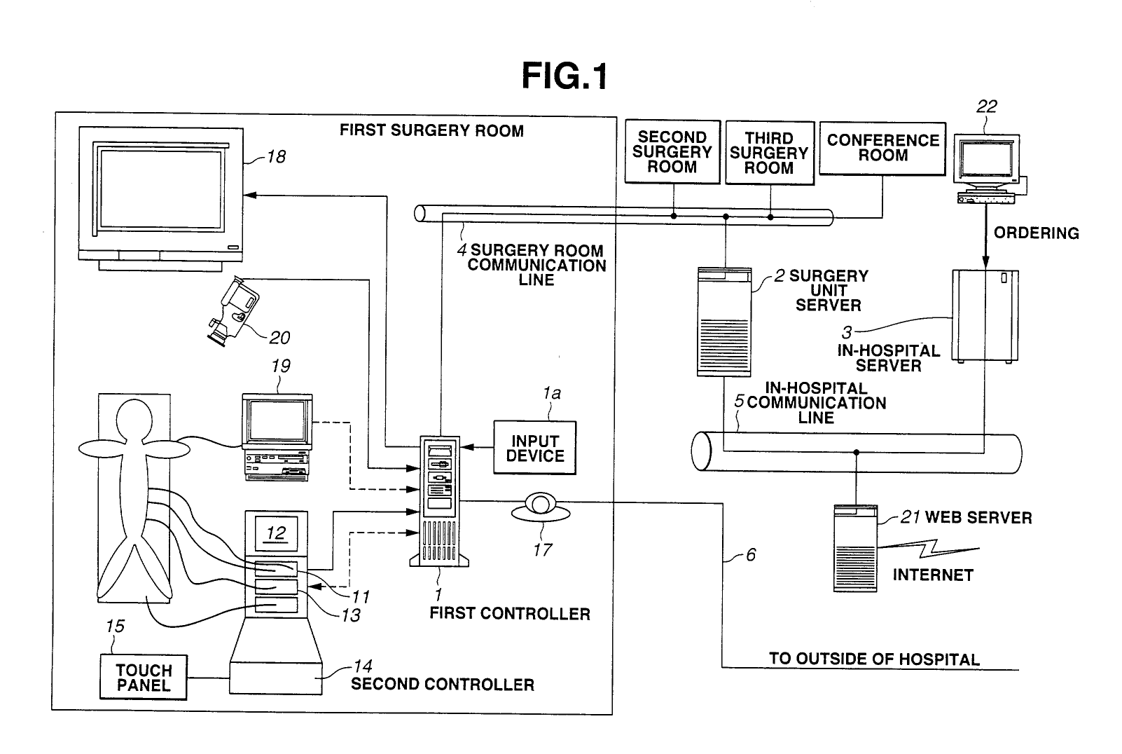

As shown in FIG. 1, the medical information processing system employed in the present embodiment comprises a first controller 1 which is installed in a base such as a surgery room or the like, and acquires various types of medical information generated in the surgery room or the like, a surgery unit server 2 which is situated at a remote location from the above surgical room, accumulates the various types of medical treatment information acquired by the above first controller 1, and creates clinical records, and an in-hospital server 3 as patient information accumulation means which is situated at a different base from the above surgery unit server 2 and makes reference to the clinical record information obtained by the above surgery unit server 2, wherein the above first controller 1 and the above surgery unit server 2, and the above surgery unit server 2 and the above in-hospital server 3, are connected by first and second communication lines 4 and 5, respectively. Note that the foregoing communication lines 4 and 5 may be any communication line, such as a public line, private line, LAN (local area network), or the like. Also, the foregoing in-hospital server 3 may be situated at the same base as the foregoing surgery server 2.

A second controller 14 comprises an endoscope device 11 for taking pictures of a subject such as within the body cavity of a patient and for acquiring picture signals including endoscope images, a display device 12 for displaying the picture signals acquired by the endoscope device 11, and a surgical device 13 such as an electrocauterizer device, gas insufflator, ultrasonic surgical device 13, or the like, wherein the second controller 14 controls the above surgical device 13, and acquires surgical device information such as measurement information and so forth from the above surgical device 13.

The second controller is connected to surgical device control input means such as a touch panel 15 for inputting control instructions and so forth for the above surgical device 13 to the above second controller 14.

The surgical device information provided from the above second controller 14 and the patient information obtained from a organism monitoring device 19 is accumulated in the first controller 1 via the communication line, and is transmitted to the surgery unit server 2 situated at a different base via the communication line 4.

Also, the picture signals acquired from the above endoscope device 11 and the picture signals acquired from an in-room camera 20 for taking pictures of the scene in the surgery room is input to a signal transmission device 17 via the first controller 1, and is transmitted externally via the communication line 6.

Also, arranged in the surgery room is a display device 18 or the like for displaying the surgery device information acquired by the first controller 1, the patient information obtained from the surgery unit server 2, and the information received by the above signal transmission device 17 from another base.

The surgery unit server 2 is connected to the in-hospital server 3 and a Web server 21 via the communication line 5. Note that the above Web server 21 is also connected externally from the hospital via the Internet.

The in-hospital server 3 accumulates patient registration information from a patient registration terminal 22 in the hospital, pre-surgery images corresponding to the patient, and medical images such as in-surgery images (MR, CT, x-ray images and so forth). The surgery unit server 2 reads out the registration information such as the name, the date of birth, and diagnosis records of the patient having surgery, and the medical images corresponding to the patient, via the communication line 5 from the in-hospital server 3.

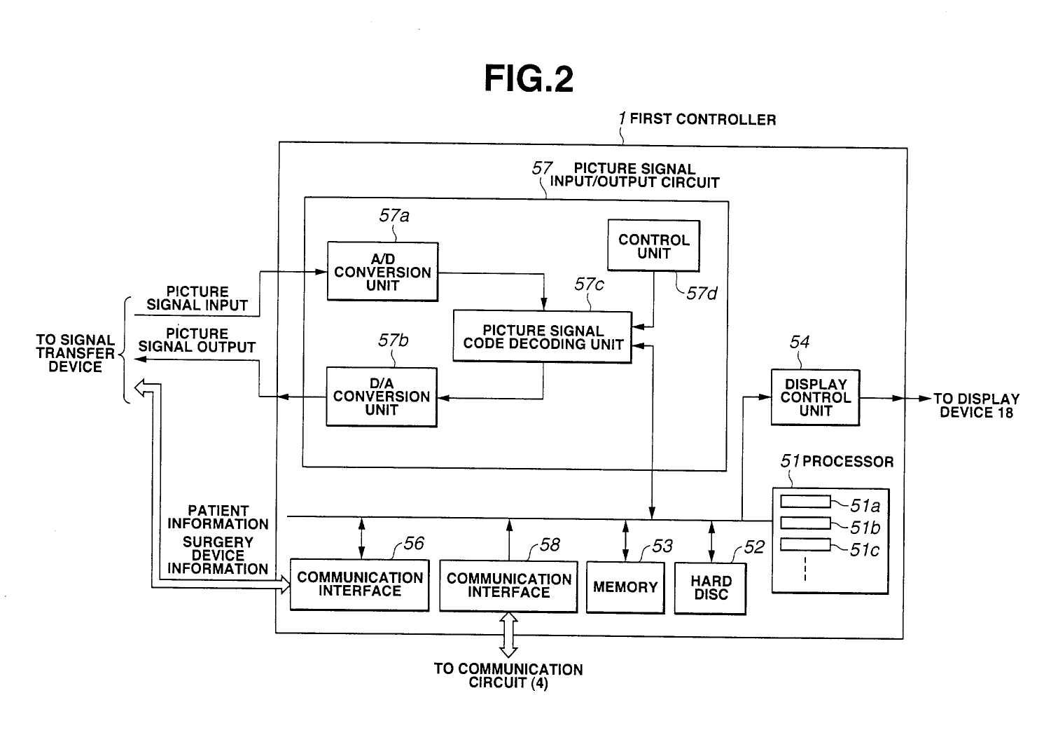

As shown in FIG. 2, the first controller 1 comprises: a processor 51 which controls each unit of the first controller 1; a hard disk 52 and memory 53 for storing software which the processor 51 executes and data such as the above endoscope images and the above patient information, and for securing work area for the processor 51; a display control unit 54 for creating picture signals for driving the above display device 18, a communication interface 56 for transmitting organism information, surgery device information, and so forth, with the organism monitoring device 19 or the second controller 14, a picture signal input/output circuit 57 which inputs and outputs picture signal information including endoscope images to and from the above signal transmission device 17, and a communication interface 58 for transmitting information via the above first communication line 4.

The foregoing processor 51 includes an information accumulation unit 51a for accumulating software stored in the hard disk 52 and the memory 53, as well as patient information, surgery device information, and so forth input individually via the above communication interfaces 56 and 58, a display information creating unit 51b for editing the information accumulated by the information accumulation unit 51a, and creating screen information displayed on the display device 18, a clinical record creating unit 51c for editing the accumulated information and creating output clinical records, and so forth.

The foregoing image picture input/output circuit 57 comprises an A/D conversion unit 57a for converting input analog picture signals into digital picture signals, a D/A conversion unit 57b for converting digital picture signals into analog picture signals and outputting the analog picture signals, a picture signal code decoding unit 57c having functions for decoding the picture signals input via the A/D conversion unit 57a, extracting desired endoscope picture signals from those input picture signals and encoding output picture signals which are provided to the D/A conversion unit 57b, and a control unit 57d for controlling each unit of the picture signal input/output circuit 57, such as the picture signal code decoding unit 57c.

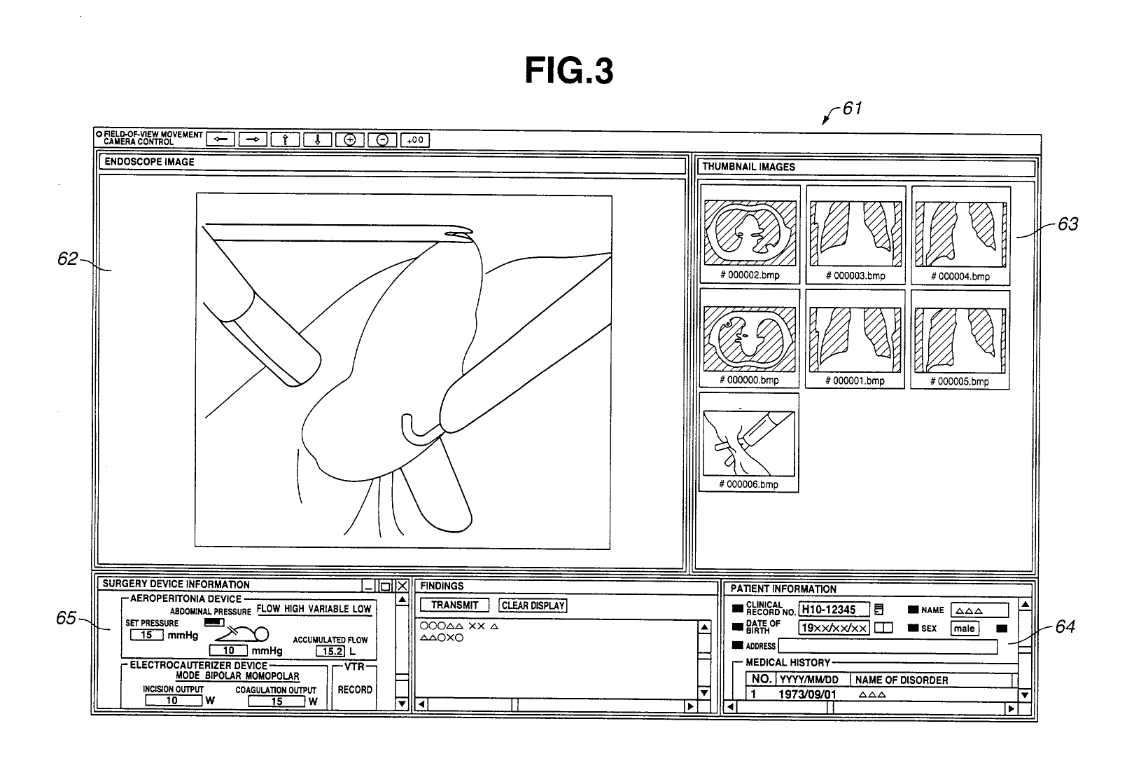

Also, as shown in FIG. 3, arranged on a summarized information screen 61 displayed on the above display device 18 by the output from the first controller 1 are; an endoscope image area 62 for displaying endoscope images, a thumbnail image area 63 for displaying a plurality of thumbnail images reduced by thinning out the pixels of the endoscope image or the like, a patient information area 64 for displaying patient information, a surgery device information area 65 for displaying surgery device information, that is to say the operation status of the surgery device 13, and so forth.

The first controller 1 is connected to an input device 1a. The input device 1a may be a keyboard, magnetic card reader, optical card reader, IC card reader, bar code reader, or the like, which is used to input a clinical record number (or ID number) and a name in the patient information area 64 shown in FIG. 3. Note that the input device 1a may be connected to the second controller 14. In the event that the input device 1a is connected to the second controller 14, the patient information is transmitted from the second controller 14 to the first controller 1.

The operations of the medical information processing system as configured above will now be described.

The picture signals including endoscope images obtained by the endoscope device 11 at the time of endoscope examination are converted into digital signals by the A/D conversion unit 57a of the picture signal input/output circuit 57 provided in the first controller 1, and are decoded by the picture signal code decoding unit 57c. At that time, as necessary, the picture signal code decoding unit 57c extracts desired endoscope images included in the picture signals under the control of the control unit 57d controlled by the processor 51. The endoscope image data acquired by the picture signal input/output circuit 57 is accumulated in the information accumulation unit 51a.

On the other hand, the surgery device information obtained by the second controller 14 from the touch panel 15 and the surgery device 13, and patient information obtained from the organism monitoring device 19, is accumulated in the information accumulation unit 51a provided in the first controller 1 via the communication line. Also, on the other hand, the patient information input from the input device 1a is accumulated in the information accumulation unit 51a provided in the first controller 1.

As described above, the information such as endoscope image information, surgery device information, and patient information, which is input from a different device or generated in a different situation, respectively, is accumulated in the information accumulation unit 51a provided in the first controller 1.

The information accumulated by the above information accumulation unit 51a is edited by the display information creating unit 51b for screen display, and the summarized information screen 61 is displayed on the display device 18 (see FIG. 3). Displayed on the summarized information screen 61 in a summarized manner are: endoscope image information, patient information, and surgery device information, and so forth, which is input from individual input devices, or is generated in a different situation.

That is to say, the first controller 1 reads out the diagnosis records and pre-surgery images (MR, CT, x-ray images, and so forth) of the patient accumulated in the in-hospital server 3 via the surgery unit server 2 based upon the patient information input from the input device 1a, and displays correlated information in the thumbnail image area 63 and the patient information area 64 on the summarized information screen 61 displayed on the display device 18.

An arrangement may be made wherein, in the event that one of the thumbnail images is selected from among the thumbnail images of the endoscope images displayed on the thumbnail image area 63 on the summarized information screen 61, the endoscope image corresponding to the selected thumbnail image is displayed on the endoscope image area 62.

Also, the information accumulated by the above information accumulation unit 51a is edited by the clinical record creating unit 51c, and clinical records are created.

As described above, according to the present embodiment, the medical treatment information such as endoscope images, surgery device information, and patient information, which is generated in a different input device or in a different situation is accumulated in the first controller 1, which edits the summarized information screen 61 including the clinical records which summarize accumulated information, and displays these on the display device 18, and thus, the time of collecting and accumulating medical treatment information is reduced, thereby, the effect of improving efficiency of the clinical record creating operations can be obtained.

Also, the first controller 1 is capable of accumulating not only the endoscope image information acquired by the endoscope device 11 but also the information at a greater variety of related devices such as various surgery devices 13.

Also, in the event that the name and ID code of the patient input from the input device 1a do not correspond to those read out from the in-hospital server 3, the first controller warns of the absence of the corresponding patient by blinking or the like an information display window for identifying the patient displayed in the patient information area 64 on the summarized information screen 61 displayed on the display device 18, for example, a window in which the clinical record No. is displayed. An arrangement may be made wherein a blinking area is specially provided on the patient information area, which is blinked in the event of the absence of the corresponding patient.

Moreover, an arrangement may be made wherein, at this time, still information closely related to the patient, such as the thumbnail image area 63, the patient information area 64, surgery device information area 65, and so forth, is not displayed, but only the endoscope image area 62 of which images are live and moving.

Thus, in the event that the patient information (e.g., the name and ID code of the patient) input from the input device 1a is not corresponding to that read out from the in-hospital server 3, the warning is displayed on the display device 18, and thus error-free clinical record management operations can be realized.

Also, the first controller 1 integrates the patient information and pre-surgery images obtained from the in-hospital server 3 via the surgery unit server 2, endoscope images acquired during surgery, and recorded information on the surgery device used in surgery, into a single electronic file, which is transmitted to the surgery unit server 2. The in-hospital server 3 reads out the above integrated electronic file of the surgery record from the surgery unit server 2, and places the above information into the electronic clinical records which deal with every aspect of medical examination, diagnosis, treatment, etc. which the patient undergoes at the hospital.

Also, the patient information and pre-surgery images accumulated in an external hospital can be read out from the Web server 21, and can be referred to with the above surgery unit server 2, as well as those accumulated in the above in-hospital server 3.

Second Embodiment

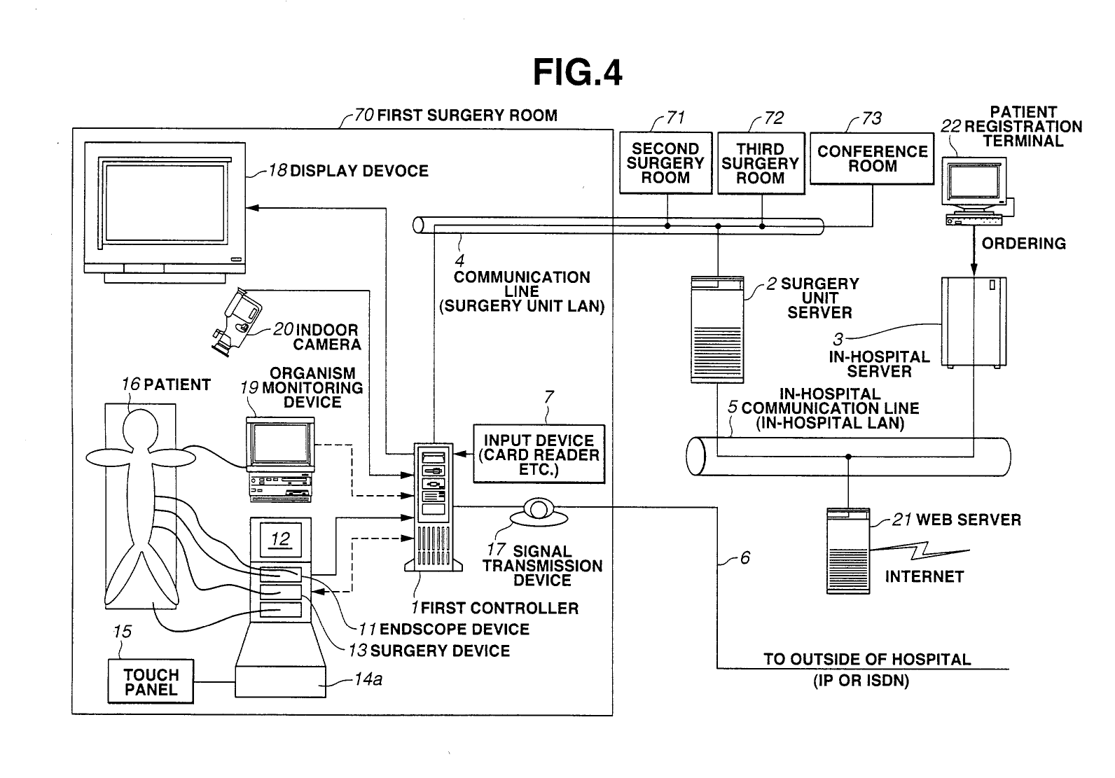

As shown in FIG. 4, the medical information processing system of the present embodiment comprises: a first controller 1 which is installed in a base such as a surgery room or the like, for acquiring medical device information (e.g., endoscope device information and surgery device information) generated in a first surgery room 70 and various types of medical information including patient information; an endoscope device 11 which is installed in the surgery room 70, for observing the subject such as inside the body cavity of a patient 16, and acquiring endoscope image information which is provided to the first controller 1; a surgery device 13 which is installed in the surgery room 70, for performing medical treatment including surgery to the patient 16, and providing the medical treatment information to the first controller 1; a display device 12 for displaying the above endoscope image information; a organism monitoring device 19 for acquiring organism information such as the blood pressure, pulse, or the like of the patient, which is provided to the first controller 1; a surgery unit server 2 which is installed at a remote location from the above surgery room 70, for accumulating various types of medical treatment information acquired by the above first controller 1, and creating clinical records; a second controller and a third controller, which are installed in a second surgery room 71 and in a third surgery room 72, respectively, and are not shown; an in-hospital server 3 serving as patient information accumulation means, which is installed in a different base from the above surgery unit server 2, for acquiring the clinical record information (medical treatment information such as the condition of the patient, administration of medicine, or the like) obtained by the above surgery unit server 2, which is consolidated and integrated; a patient registration terminal 22 which is connected to the in-hospital server 3, for inputting patient registration information; an input device 7 (e.g., keyboard, magnetic card reader, bar-code reader, or the like) serving as input means, which is connected to the above first, second, and third controllers, for inputting the information for identifying the patient; a display device 18 for displaying endoscope images, surgery device information, patient information, thumbnail images, diagnosis made by surgeons, and so forth, in a summarized manner; communication lines 4 and 5, serving as communication means, which connect the above first controller 1, the second controller, and the third controller with the above surgery server 2, and the above surgery unit server 2 with the above in-hospital server 3, respectively.

The medical devices such as the above endoscope device 11, the display device 12, the surgery device 13, and so forth, are stored in a sub-controller 14a which is connected to a touch panel 15 for outputting control instructions for the medical devices.

Moreover, a conference room 73 having a TV conference system or the like, for monitoring the status of each surgery room, and for giving instructions of the medical treatment, is connected to the above communication line 4 as the above multiple surgery rooms 70, 71, and 72, while a Web server 21 for performing exchange of information with an external hospital or the like, is connected to the communication line 5.

In the surgery room 70, an in-room camera 20 which is connected to the first controller 1 for taking pictures of scene in the room is installed. The in-room camera 20 can be made to control the camera angle based upon the instructions of camera position or the like from surgeons in the conference room in the event that the surgeons in the conference room 73 and surgeons in charge in the surgery room 70, 71, or 72, perform surgery while talking with the TV conference system, or the like.

Note that the above communication lines 4 and 5 may be any communication line such as a public line, private line, LAN (local communication network), or the like.

The structure of the above second and third surgery room 71 and 72 is the same as that of the first surgery room 70, so description thereof will be omitted. Also, the above in-hospital server 3 may be installed in the same base as the above surgery unit server 2.

The sub-controller 14a includes: the endoscope device 11 for taking pictures of a subject such as inside the body cavity of a patient, and acquiring picture signals including endoscope images; the display device 12 for displaying picture signals acquired by the endoscope device 11; and a surgery device 13 such as an electrocauterizer device, gas insufflator, ultrasonic surgical device, wherein the sub-controller 14a controls the above surgery device 13, and acquires the surgery room device information such as measurement information from the above surgery device 13. The sub-controller 14a is connected to surgery device control input means such as the touch panel 15 for inputting control instructions and so forth for the surgery device 13 to the sub-controller 14a.

The surgery room device information provided from the above sub-controller 14a and the patient information obtained from the organism monitoring device 19 is accumulated in the first controller 1 and is transmitted to the surgery unit server 2 installed in a different base via the communication line.

The picture signals obtained from the above endoscope device 11 and the picture signals obtained from the in-room camera 20 for taking pictures of the scene of the surgery room are transmitted to the conference room 73 through the first controller 1 and via the communication 4, and are input to the signal transmission device 17 via the first controller 1, and transmitted externally via the communication line 6.

The surgery room 70 has the display device 18 for displaying the surgery room device information obtained by the first controller 1, the patient information such as pre-surgery images and clinical history, obtained from the surgery unit server 2 based upon the in-hospital server 3, and the information received from different base externally from the hospital by the signal transmission device 17. The surgery unit server 2 is connected to the in-hospital server 3 and the Web server 21 via the communication line 5. The in-hospital server 3 stores the patient registration information from the patient registration terminal 22 of the hospital and clinical record information such as clinical history, medical treatment information, and medical image information correlated to each patient. The surgery unit server 2 reads out the registration information such as the name, the date of birth of the patient having surgery, diagnosis records (clinical history, medical treatment, etc.) related to the patient, and medical images via the communication line 5.

While the input device (keyboard, magnetic card reader, bar-code reader, etc.) is connected to the first controller 1 in FIG. 4, it should be understood that the present embodiment is not intended to be limited to this form, and it is needless to say that other arrangements may be made, such as an arrangement wherein the sub-controller 14a is connected to the input device 7, and the patient information is transmitted to the first controller 1 from the sub-controller 14a.

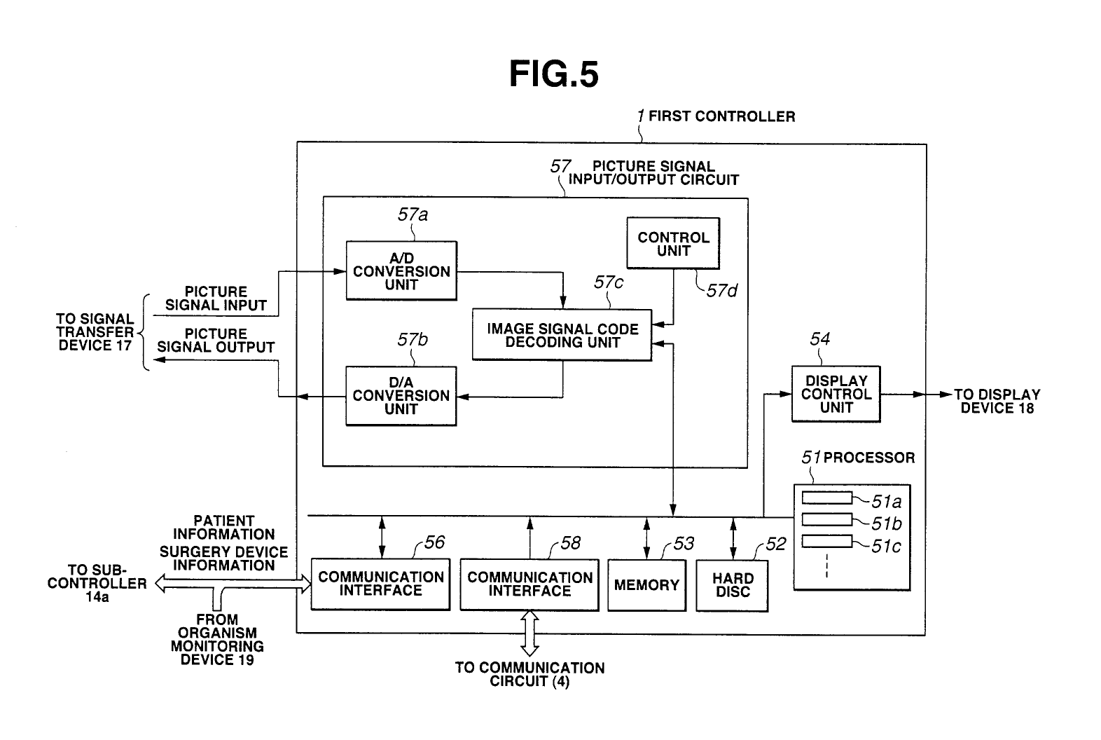

FIG. 5 is a block diagram which indicates the configuration of the first controller 1 shown in FIG. 4.

As shown in FIG. 5, the first controller 1 comprises: a processor 51 for controlling each unit of the controller 1; a hard disk 52 and memory 53, for storing software which the processor 51 executes and data such as the above endoscope images, the above surgery room information, and the above patient information, and for securing work area for the processor 51; a display control unit 54 for creating picture signals for driving the above display device 18; a communication interface 56 which is connected to the above organism monitoring device 19 and the sub-controller 14a, for transmitting the organism information, surgery device information, and so forth; an picture signal input/output circuit 57 for inputting and outputting the picture information including endoscope images from and to the above signal transmission device 17; a communication interface 58 for transmitting information via the above communication line 4.

The above processor 51 includes: an information accumulation unit 51a for accumulating the patient information, the organism information, the surgery device information, and so forth, input for each patient, via the above communication interface 56 and 58, as well as software stored in the above hard disk 52 and the memory 53; a display information creating unit 51b for editing the information accumulated by the information accumulation unit 51a, and creating image information displayed on the display device 18; and a clinical record creating unit 51c for editing the accumulated information, and creating clinical records, and so forth.

The above picture signal input/output circuit 57 comprises: an A/D conversion unit 57a for converting input analog picture signals to digital picture signals; a D/A conversion unit 57b for converting digital picture signals to analog picture signals; a picture signal code decoding unit 57c having functions for decoding the picture signals input via the above A/D conversion unit 57a, extracting desired endoscope image signals from the input picture signals, encoding output picture signals to be provided to the D/A conversion unit 57b; a control unit 57d for controlling each component of the picture signal input/output circuit 57 such as the picture signal code decoding unit 57c.

As shown in FIG. 3, as with the first embodiment, arranged on a summarized information screen 61 displayed on the above display device 18 by the output from the above first controller 1 are: an endoscope image area 62 for displaying endoscope images; a thumbnail image area 63 for displaying a plurality of thumbnail images reduced by thinning out the pixels of the endoscope image, or the like; a patient information area 64 for displaying patient information; and a surgery device information area 65 for displaying surgery device information, and so forth.

The operations of the present embodiment described above will now be described.

The first controller 1 is connected to the input device 7 (e.g., keyboard, magnetic card reader, bar-code reader, etc.), and enables a user to input the clinical record number (ID number) and the name in the patient information area 64 in FIG. 3. The controller 1 reads out the diagnosis records and pre-surgery images (e.g., MR, CT, x-ray images, etc.) of the patient accumulated in the in-hospital server 3 via the surgery unit server 2 based upon the patient information input by the above input device 7, and displays the related information on the above thumbnail image area 63 and the patient information area 64 on the above display device 18.

In the event that patient information (name, ID code) is input with the input devices in a first, second, and third surgery rooms, 70, 71, and 72, the patient information which is input in each surgery room is recorded on the fixed area of the in-hospital server 3. That is to say, since all the patient information in each surgery room 70, 71, and 72, is stored in the in-hospital server 3, a user can easily judge whether the patient information which is input to the first controller 1 and the patient information which is input in the second surgery room 71 or the third surgery room 72 next door, are the same, by the first controller 1 in the first surgery room 70 referring to the in-hospital server 3.

In the event that the information in the name and ID code of the patient which is input to the input device 7 agrees with that which is input to the second or third controller installed in other operation rooms 71 and 72, and is read out from the in-hospital server 3, the first controller 1 judges that an input error has occurred (that trouble of mistaking one patient for another may occur), resulting in detection of the same patient in multiple surgery rooms, and gives a warning by blinking the display window of the patient information (e.g., ID number) in the patient information area 64 on the display device 18.

An arrangement may be made, wherein, at this time, only the endoscope image area 62 of which images are live and moving, is displayed without displaying the thumbnail image area 63, the patient information area 64, the surgery device information area 65, and so forth, of which still information closely related to the patient, is read out from the in-hospital server 3. This is due to the following reasons. That is, in cases wherein surgeons in the conference room 73 and the surgeons in charge in the surgery room perform surgery while talking over the TV conference system (including the in-room camera 20) or the like, in the event of detection of the same patient information in a plurality of controllers in a plurality of surgery rooms, even if the conference room 73 or each controller reads out the clinical record information of the patient from the in-hospital server 3 and displays the information on the summarized screen as shown in FIG. 3, there is a high probability that the clinical record information such as the thumbnail image area 63, the patient information area 64, and the surgeon device information area 65, may be different from the clinical record information of each of the patients in each of the rooms, and accordingly this arrangement is unreliable. On the other hand, the moving images in the surgery room where the surgeons are talking, such as the endoscope images, are the images for specifying the patient in the surgery room, and are the live images being taken under the request of the conference room 73, so these images are transmitted for displaying. However, information such as the pre-surgery images and surgery history which is read out from the in-hospital server 3 based upon the patient information (which is detected in multiple surgery rooms, and accordingly there is a high possibility that this is wrong), is unreliable, so the information is not displayed.

In the event that multiple controllers each of which is installed in each of a plurality of surgery rooms, detect the same patient information at the same time, since the first controller 1 can perform exchange of information with the individual controllers in the second and the third surgery rooms, each controller can be adjusted (by programming) not to read out the clinical records of the patient from the in-hospital server 3 if it is confirmed that the same patient information is detected in these multiple controllers. Also, an arrangement may be made (by programming) wherein in the event that the in-hospital server 3 judges that the patient information which is stored in the fixed area, and is input in every surgery room, is the same, the in-hospital server 3 prohibits the readout of the information without responding to the readout request, even if the in-hospital server 3 receives the readout request.

Let us now consider a case of transplant surgery as an example of surgery being performed as surgeons monitor the progress in each of multiple surgery rooms, not only between a surgery room and a conference room. One arrangement of this case is wherein surgery is performed as progress information is exchanged via the communication line between a surgery room where one of the lungs of a donor is being removed, and a surgery room where a recipient is receiving transplant surgery of the lung. Taking this into mind, an arrangement is desirable wherein the above live moving images are transmitted to other surgery rooms or the like, not to limit to the conference room.

In normal conditions wherein the same patient information is not detected in the multiple controllers, the first controller integrates the patient information and pre-surgery images obtained from the in-hospital server 3 via the surgery unit server 2, endoscope images acquired during surgery, and recorded information on the surgery device 13 used in surgery, into a single electronic file, which is transmitted to the surgery unit server 2. The in-hospital server 3 reads out the above integrated electronic file of the surgery record from the surgery unit server 2, and places the above information into the electronic clinical records which deal with every aspect of medical examination, diagnosis, treatment, etc., which the patient undergoes at the hospital.

The above Web server 21 is connected externally from the hospital via the Internet. The above surgery unit server 2 can read out and refer to the patient information and pre-surgery images accumulated in an external hospital from the above Web server 21, in addition to those stored in the in-hospital server 3.

It should be understood that the present invention is not intended to be limited to the embodiments described above; rather, various modifications may be made without departing from the essence of the invention. Also, other storage means such as a magneto-optical disk may be employed, for example, instead of the hard disk 52.

It is clear that a wide variety of embodiments may be made based upon the present invention without departing from the spirit and scope of the invention. The present invention is not to be restricted by particular embodiments except as limited by the appended Claims.

What is claimed is:

1. A medical information system comprising:
a controller which is connected to a surgery system for surgery, for receiving information from said surgery system;
a server which is connected to said controller, for accumulating identification information for identifying a patient having surgery with said surgery system; and
an input device which is connected said controller, for inputting said identification information;
wherein said controller collates said identification information from said input device with that from said server.

2. A medical information system according to claim 1, wherein said server further accumulates the personal information of a patient, related to said identification information;
and wherein said controller creates clinical record information by the information from said surgery system and said personal information based upon collation results.

3. A medical information system comprising:
a first controller, which is connected to a surgery system installed in a first surgery room, and is installed in said first surgery room, for receiving information from said-surgery system;
a communication interface which is provided in said first controller, and is connected to a communication line connected to a second controller installed in a second surgery room;
a server which is connected via said communication line, for accumulating identification information for identifying a patient having surgery with said surgery system; and
an input device which is connected to said first controller, for inputting said identification information;
wherein said first controller collates said identification information input by said input device with said identification information related to patient information accumulated in said server, and checks that said identification information is not detected via said communication interface.

4. A medical information system according to claim 3, wherein said server furthermore accumulates personal information of a patient, related to said identification information;
and wherein said controller creates clinical record information by information from said surgery system and said personal information based upon collation results.

5. A medical information system comprising:
a controller for collecting information from medical devices used in contact with a patient;
input means which are connected to said controller, for inputting information for identifying said patient;
patient information accumulation means for accumulating patient identification information; and
communication means for connecting said controller with said patient information accumulation means;
wherein said controller collates information for identifying said patient, which is read out from said patient information accumulation means, with patient information which is input from said input means, and reads out related information of the same patient from said patient information accumulation means.

6. A medical information system according to claim 5, wherein said controller displays the display which indicates failure in collation, in the event that patient identification information in said patient information accumulation means cannot be collated with patient information which is input from said input means.

7. A medical information system according to claim 6, wherein: said controller transmits only live and moving images, and does not transmit patient information and operation status of surgery devices in the event that the above patient information cannot be collated.

8. A medical information system according to claim 6, wherein said input means is one of a magnetic card reader, optical card reader, IC card reader, and bar-code reader.

9. A medical information system according to claim 6, wherein said input means is a keyboard.

10. A medical information processing system comprising a first controller for collecting information from medical devices including endoscope devices and surgery devices used in contact with a patient;
input means connected to said first controller, for inputting information for identifying said patient;
patient information accumulation means for accumulating information for identifying said patient, and clinical record information;
at least one other controller which is each installed in a different medical sector from said first controller, for collecting information from medical devices similar to said medical device used in contact with a patient; and
communication means for connecting said first controller, said other controllers, and said patient information accumulation means;
wherein said first controller collates the information for identifying a patient which is read out from said patient information accumulation means, with the information for identifying a patient which is input from said input means, and in the event that it is confirmed that information for identifying the same patient as the above patient is not detected with said other controllers, said first controller reads out clinical record information related to the patient who is identified in said collation from said patient information accumulation means.

11. A medical information processing system comprising:
a first controller for collecting information from medical devices used in contact with a patient;
input means which is connected to said first controller, for inputting information for identifying a patient;
patient information accumulation means for accumulating information for identifying said patient; and
communication means for connecting said first controller and at least other one controller installed in a different medical sector from said first controller, and having the same function as said first controller, and said patient information accumulation means;
wherein said first controller collates information which is read out from said patient information accumulation means, for identifying a patient, with patient information which is input from said input means, and in the event that it is confirmed that no other controllers are adapted to said patient, said first controller reads out information related to the identified patient from said patient information accumulation means.

12. A medical information system according to claim 11, wherein said first controller transmits only live and moving images, and does not transmit patient information and operation status of surgery devices, in the event that other controllers are adapted to the same patient.

13. A medical information system according to claim 11, wherein said input means is one of a magnetic card reader, optical card reader, IC card reader, and bar-code reader.

14. A medical information system according to claim 11, wherein said input means is a keyboard.

15. A medical system comprising:
a surgery system including a plurality of medical devices for surgery and a first controller for monitoring operation status of said plurality of medical devices;
a server for registering and accumulating identification information for identifying a patient having surgery with said surgery system;
an input device for inputting said identification information; and
a second controller which communicates with said server and is connected to said first controller and said input device, for collating said identification information from said server with said identification information from said input device.
